(19) United States
(12) Patent Application Publication
(10) Pub. No.: US 2011/0075288 A1
(43) Pub. Date: Mar. 31, 2011

(54) MAGNETIC RECORDING MEDIUM

(75) Inventors: Alexander Krichevsky, San Jose, CA (US); Sakhrat Khizroev, Riverside, CA (US); Ilya Isaakovich Dumer, Riverside, CA (US); Andrey Alekseyevich Lavrenov, San Jose, CA (US); Nissim Amos, Moreno Valley, CA (US)

(73) Assignee: THE REGENTS OF THE UNIVERSITY OF CALIFORNIA, Oakland (CA)

(21) Appl. No.: 12/995,152

(22) PCT Filed: May 29, 2009
(86) PCT No.: PCT/US09/45740

§ 371 Date: Nov. 29, 2010

Related U.S. Application Data
(62) Division of application No. 61/057,699, filed on May 30, 2008.

(51) Int. Cl. G11B 5/82; G11B 5/127; G11B 5/09; G11B 27/36; G11B 5/64; B05D 5/00

(52) U.S. Cl. 360/31; 360/135; 360/110; 360/39; 428/800; 427/131; G9B/5.293; G9B/5.04; G9B/5.033; G9B/27.052

(57) ABSTRACT

A novel magnetic recording medium is disclosed in which a plurality of magnetic data recording layers and navigation layers are separate from one another. By decoupling the navigation and data layers, data may be written to data layers without the need to align the written data along servo tracks. Thus, the data layers may be configured for high recording density. Beneficially, imperfections within the magnetic data layers may also be compensated for by the use of adaptive error correction schemes which vary the encoding/decoding of data during writing/reading based upon the local quality of the recording media.

### STATEMENT REGARDING FEDERALLY SPONSORED R&D

This invention was made with Government support under Contract Number H94003-06-20604 awarded by Department of Defense (DOD/DMEA-CNN). The Government has certain rights in this invention.

### BACKGROUND

1. Field of the Invention

Embodiments of the present disclosure pertain to magnetic recording media and, in particular, to magnetic recording media in which data and navigation information are written to different layers of the recording media

2. Description of the Related Art

The aerial disk recording density of magnetic media within modern hard disk drives has increased at a pace of tens of percents annually in recent years through a series of breakthroughs. For example, perpendicular recording, where magnetic bits are oriented perpendicular to the disk platters, has the potential to achieve storage densities on the order of about 1 Terabit per square inch. These systems may include high-coercivity data recording layers which possess out-of-plane anisotropy and separate, soft magnetic underlayers. This configuration enhances the write performance of single pole recording devices as the soft underlayer effectively acts as part of the write head, making the read/write head more efficient, which in turn allows for the use of magnetic materials having greater coercivity and thermal stability.

In hard disk drive systems, digital data is often encoded on rigid, substantially circular platters configured with a magnetic media, such as ferromagnetic films. In order to facilitate navigation and reading/writing of data to the hard disk drive, the magnetic media may be divided into a plurality of tracks which are substantially co-centric with respect to the platter. Each track may be further subdivided into a plurality of substantially equal arcs. These subdivided arcs of the co-centric tracks may be designated as either servo tracks or data tracks. Servo tracks comprise a special pattern which is written at the start of each subdivided track. Feedback from a read/write head of the hard disk drive, which reads the pattern, is used to accurately position the read/write head over desired data tracks.

However, conventional systems may face increasing difficulty progressing significantly beyond 1 Terabit per square inch densities. Notably, recording densities, even in perpendicular recording media, are substantially limited by the size of the grains of the ferromagnetic materials comprising the magnetic medium. For example, it takes approximately 50-80 grains to compose a single bit which provides meaningful signal strengths to overcome the noise created by randomness in the grain size and magnetization. Reducing the number of grains within the bits to further increase storage density may result in demagnetization by heat and loss of data.

Thus, there exists a continued need for improved magnetic media for high density recording.

### SUMMARY

In an embodiment, a magnetic recording medium is provided. The magnetic recording medium comprises:

a first recording layer to which a first data may be magnetically recorded;

a second recording layer to which a second data may be magnetically recorded, where the first recording layer is positioned beneath the second recording layer and where a magnetic coercivity of the second recording layer is greater than the first recording layer;

and where the first data comprises navigation information for identifying a location of the second data within the second recording layer.

In another embodiment, a magnetic recording system is provided. The magnetic recording system comprises:

a data layer to which first data may be magnetically recorded;

a navigation layer to which navigation data may be magnetically recorded, where a magnetic coercivity of the data layer is greater than the navigation layer and where the navigation data identifies the location of the first data within the data layer; and

a plurality of read/write poles within a single head, capable of separately reading and writing data to the data and navigation layers.

In a further embodiment, a method of recording data to a magnetic recording medium is provided. The method comprises:

selecting a portion of data layer of the magnetic recording medium to which data is to be recorded;

writing predetermined data to the data layer using selected write parameters;

determining a strength of the magnetic field of the data written to the data layer using the selected write parameters;

comparing the measured magnetic field strength to a threshold value;

determining an encoding scheme based upon the strength of the measured magnetic field when the measured magnetic field strength is greater than or equal to the threshold value; and

writing the write parameters and determined encoding scheme for the selected portion of the data layer to a navigation layer of the magnetic recording medium;

where the data and navigation layers of the magnetic recording medium are configured as separate layers of the magnetic recording medium.

In a further embodiment, a method of fabricating a magnetic recording medium is provided. The method comprises:

providing a substrate;

depositing a first magnetic layer over the substrate to which first data may be magnetically written and read; and

depositing a second magnetic layer over the first magnetic layer to which second data may be magnetically written and read;

where the magnetic coercivity of the second magnetic layer is greater than that of the first magnetic layer and where the first data comprises navigation information for identifying a location of the second data within the second recording layer.

In an additional embodiment, a magnetic recording device for reading and writing data magnetically to a magnetic recording medium is provided. The magnetic recording device comprises:

a reading and writing head, comprising:

a first magnetic pole; and

a second magnetic pole;

where the width of the second magnetic pole is less than the width of the first magnetic pole and where the second magnetic pole is configured to generate a maximum magnetic field strength which is greater than that of the first magnetic pole.

### BRIEF DESCRIPTION OF THE DRAWINGS

FIG. 1 is a cross-sectional view of one embodiment of a magnetic recording medium including data and navigation layers separated from each other;

FIGS. 2A-2C are cross-sectional views of embodiments of the magnetic recording medium of FIG. 1 having data layers formed through different techniques; (2A) nanoimprint lithography; (2B) self-assembled nanoparticles; (2C) continuous media;

FIG. 3 is a schematic of one embodiment of a nanoimprinted data layer comprising hexagonal patterned elements;

FIG. 4 is a schematic of one embodiment of a nanoimprinted data layer comprising square/rectangular patterned elements;

FIG. 5 is a schematic of one embodiment of a disk media based upon self-assembled nanoparticles;

FIGS. 6A-6F schematically illustrate one embodiment of a process for nanoimprinting;

FIGS. 7A-7B are embodiments of processes for characterizing and writing data to the medium of FIG. 1;

FIG. 8 is a representation of a trajectory of the read/write head motion with respect to the rows of bits;

FIG. 9A is a schematic illustration of one embodiment of writing information to the data layer of the magnetic recording medium of FIG. 1;

FIG. 9B is a schematic illustration of one embodiment of writing information to the navigation layer of the magnetic recording medium of FIG. 1;

FIG. 9C is a schematic illustration of one embodiment of writing information to the navigation layer of the magnetic recording medium of FIG. 1A having longitudinal anisotropy;

FIG. 10 is a schematic of one embodiment of a process of writing servo information with part track-width shift;

FIGS. 11A-11C are schematic illustrations of the reading process from the data and navigation layers at different spatial frequencies; and

FIG. 12 is a plot of magnetization as a function of applied external field of an embodiment of the magnetic recording medium of FIG. 1.

### DETAILED DESCRIPTION

Embodiments of the disclosure present magnetic recording media which are configured with data and navigation (servo) information written to different layers of the magnetic recording media. The magnetic coercivity of the data layer is also configured so as to be significantly greater than that of the navigation layer. As a result, highly divergent magnetic fields may be used to write data to either the data or navigation layers without substantially interfering with data stored in the other layer.

Beneficially, by decoupling the navigation layer from the data layer, data may be written to the data layer without the need to align the written data along the servo tracks. Instead, in certain embodiments, the magnetic recording medium may be patterned through one of a variety of mechanisms and subsequently characterized before use in order to analyze the ability to write data to, and read data from, the data and navigation layers. In this manner, the data layer may employ magnetically susceptible materials with greater data aerial densities than standard ferromagnetic films but that do not require the same type of order employed in conventional servo tracking.

In further embodiments, the magnetic recording media may be configured such that data may be recorded using multi-level recording. In multi-level recording, the magnetic recording medium comprises a material which is capable of being magnetized in a plurality of ways, with several discrete levels of magnetization or even continuous transitions between saturated states. So configured, data may be written to the magnetic recording medium in a variety of states, rather than merely in a two-level, binary recording.

To date, multi-level recording has been difficult to achieve, due to the need for sufficient uniformity of the magnetic properties for each separated magnetic layer. This uniformity is required in order to distinguish multiple levels of the signal across the entire disk, as the thresholds for such differentiation are much closer spaced than in the standard two-level recording.

Use of a navigation layer which is separate from the data layer, however, can resolve this problem by adaptively assigning local thresholds and local amplifier gain for the read and write signal. Information on signal levels at different locations of the magnetic recording medium, and even the number of the levels distinguishable at and around these locations, may be written to the navigation layer. In certain embodiments, multi-level recording may be performed in the frequency domain.

In further embodiments, such novel magnetic recording media may be used with adaptive error correction schemes. These adaptive schemes vary the encoding/decoding of data during writing/reading of data based upon the local quality of the magnetic recording media. Thus, in one example, a relatively fast and simple error correction scheme may be performed to read and write data to regions of the magnetic recording media which are of relatively high quality. In another example, a relatively slower and more sophisticated error correction scheme may be performed to read and write data to regions of the magnetic recording media which are of relatively low quality. In this manner, magnetic recording media which possess regions of relatively poor quality for magnetic recording may still be used, as opposed to ignoring these regions or discarding the entire media, increasing the storage capacity of the magnetic recording media and reducing their manufacturing costs. These and other advantages are discussed below.

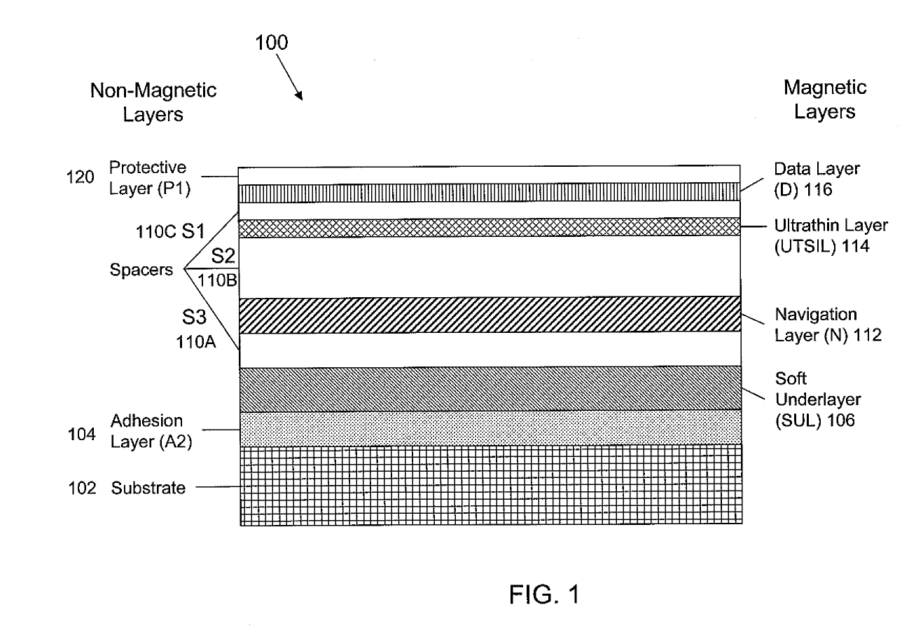

FIG. 1 illustrates one embodiment of a magnetic recording medium 100 of the present disclosure, comprising a plurality of layers. It may be understood that, in certain embodiments, not all the illustrated layers may be present. Furthermore, the number of each of the various layers present may be increased or decreased, as necessary. Also, in other embodiments, the ordering of the layers may be changed. In further embodiments, the magnetic recording medium 100 may be in communication with a plurality of processors.

A magnetic recording medium 100 comprises, in one embodiment, a substrate 102, an adhesion layer (A2) 104, a soft magnetic underlayer (SUL) 106, a plurality of spacers, for example, 110A, 110B, 110C (S1, S2, S3, respectively), a navigation layer (N) 112, an ultrathin soft magnetic interlayer (UTSIL) 114, a data layer (D) 116, and a protective layer (P1) 120.

The protective layer 120 comprises a protective and/or planarizing overcoating layer which serves to inhibit damage to the other layers. Examples of such protective layers 120 may include, but are not limited to, the Diamond-Like Carbon (DLC), nitrogenated carbon, hydrogenated carbon, silicon carbide, silicon nitride, silicon oxide, and aluminum oxide. In further embodiments, the protective layer 120 may comprise metallic, non-magnetic materials. The thickness of the protective layer 120 may range between approximately 3 to 10 nm.

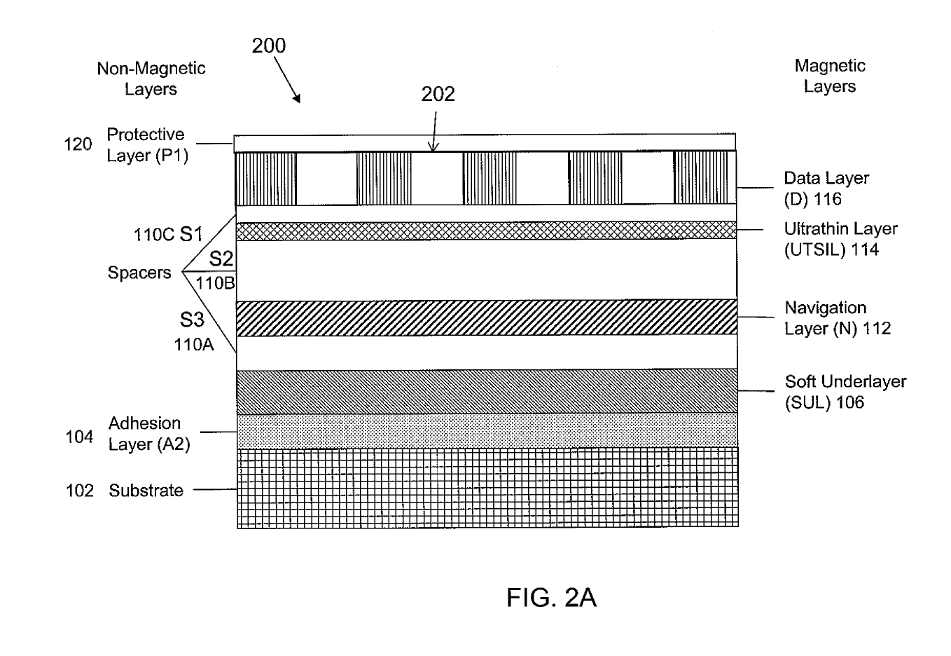

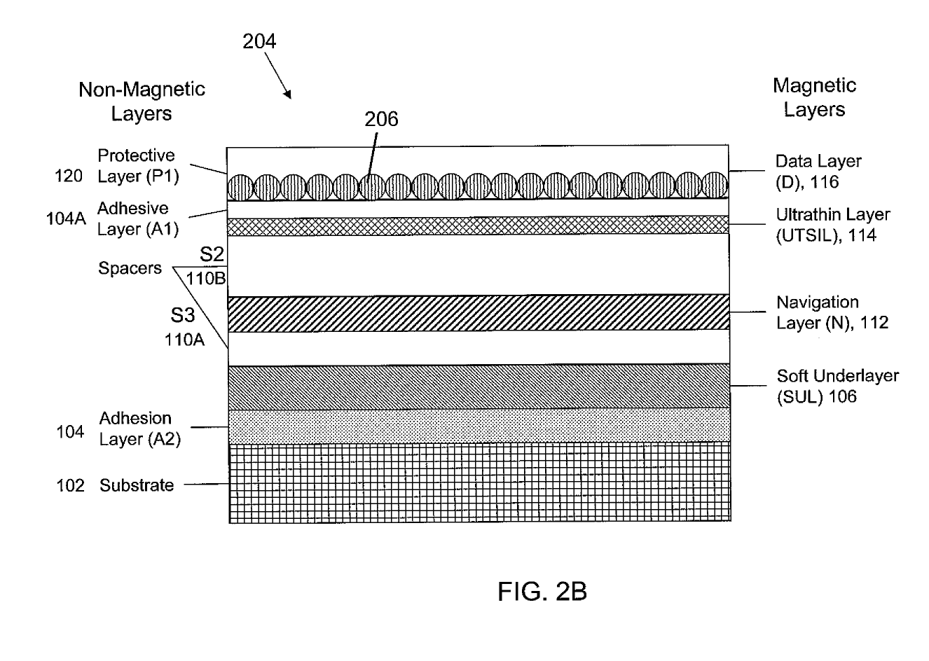

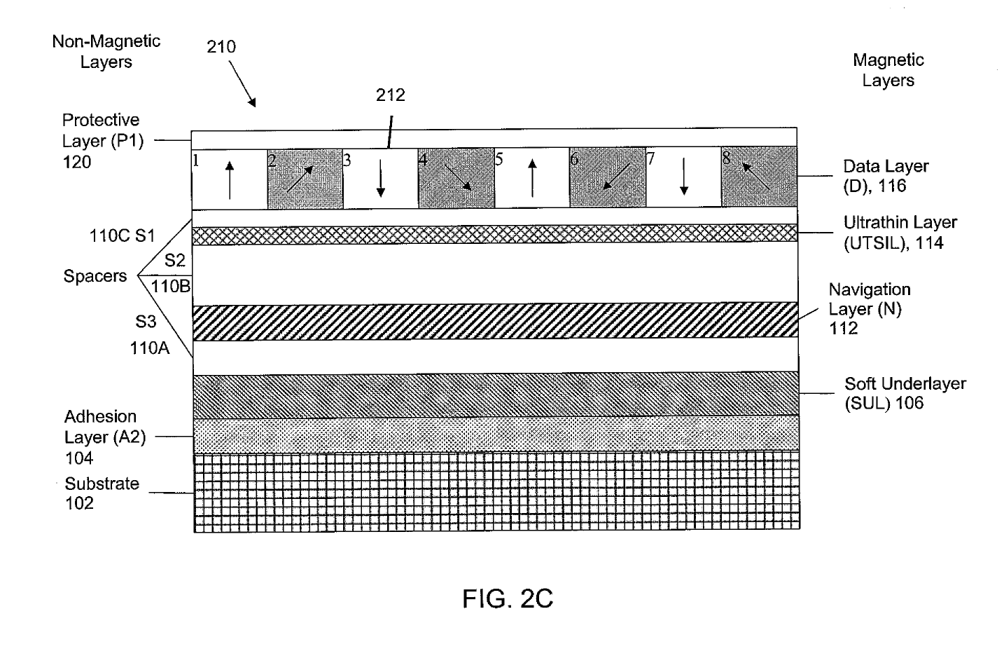

The data layer 116 comprises a layer to which data may be magnetically written and read from. As discussed below, the data layer 116 may be configured using one of nanoimprinting, self-assembled magnetic nanoparticles, and fine grained, continuous and multi-leveled media. In one embodiment, the data layer 116 comprises a highly coercive magnetic material which allows the achievement of a high aerial recording density, as discussed below with respect to FIGS. 2A-2C. A narrow write pole having a divergent magnetic field may be used to record data upon the data layer 116, as discussed below. In an embodiment, the thickness of the data layer 116 may range between about 1 to 40 nm. In further embodiments, the thickness of the data layer 116 may range between about 3 to 40 nm.

The ultrathin soft magnetic layer (UTSIL) 114 may optionally be present, in certain embodiments. The UTSIL 114 may comprise materials including, but not limited to, CoTaZrFe alloys, NiFe alloys (e.g., Permalloy), and CoTaZr alloys. The thickness of the UTSIL 114 may range between about 1-50 nm, in an embodiment. In further embodiments, the UTSIL 114 thickness may range between about 1-10 nm.

The UTSIL 114 may also be separated from the data layer 116 and the underlying navigation layer 112 by non-magnetic spacers 110C, 110B. In embodiments which employ self-assembled nanoparticles in the data layer 116, the spacer layer 110C may be replaced or combined with a second adhesive layer (A1) 104A.

Soft magnetic underlayers, such as the UTSIL 114, may be employed for use in conjunction with perpendicular recording. For example, these layers inhibit divergence of the magnetic field generated by the writing pole and enhance the strength of the writing pole by establishing in the top half-space a filed configuration similar to that created by the original writing pole and its mirror image on the other side of the UTSIL 114.

Furthermore, in one embodiment, the UTSIL 114 may act to inhibit the narrow write pole used for recording data to the data layer 116 from also recording to the navigation layer 112. The UTSIL 114 is discussed in greater detail below.

The navigational layer 112 may be employed for recording servo tracks, mapping the information recorded in the data layer 116 and, optionally, at least a portion of the file hierarchy information. In one embodiment, the navigation layer 112 comprises a magnetic material having lower coercivity than the data layer 116. In an embodiment, the thickness of the data layer 116 may range between about 1 to 50 nm. In another embodiment, the thickness of the navigation layer 112 may range between about 5-50 nm.

As the amount of data which is written to the navigation layer 112 is significantly less than that of the data layer 116, data may be written to the navigation layer 112 using thicker poles which generate a weaker magnetic field over a large area, compared to the narrow write pole employed in conjunction with the data layer 116. Such poles are not expected to perturb the magnetization of the high coercivity data layer 116 and allow information to be written to the navigation layer 112. The navigation layer 112, in certain embodiments, may possess either perpendicular or longitudinal anisotropy, as discussed below.

A soft magnetic underlayer (SUL) 106 may optionally be present in embodiments where the navigation layer 112 employs perpendicular anisotropy. The SUL 106 may be fabricated from materials including, but not limited to, CoTaZrFe alloys, NiFe alloys (e.g., Permalloy), and CoTaZr alloys. The thickness of the SUL 106 may range between about 60-600 nm, in an embodiment. When present, the SUL 106 may be separated from the navigation layer 112 by spacer 110A.

The adhesion layer 104 acts to hold the layers discussed above upon the substrate 102. The thickness of the adhesion layer 104, in an embodiment, may range between about 5 to 100 nm.

In further embodiments, the data and navigation layers 116, 112 may comprise a single layer of magnetic material or stacks including a plurality of layers of magnetic layers. The thickness of individual magnetic layers of the data and navigation layers 116, 112 may range between about 1 to 75 nm. The thickness of stacks of data and navigation layers 116, 112 may range between about 1 to 150 nm.

In certain embodiments, the composition of the data and navigation layers 116, 112 may be given according to the formula

FePtX

where Fe is iron, Pt is platinum, and X is an element that may include, but is not limited to, copper (Cu), silver (Ag), gold (Au), palladium (Pd), chromium (Cr), Carbon (C), and no element. In certain embodiments, the concentration of iron within a data or navigation layer 116, 112 may range between about 30 to 70 atomic percent (at. %), based upon the total number of atoms of the data or navigation layer 116, 112. In other embodiments, the concentration of platinum within a data or navigation layer 116, 112 may range between about 30 to 70 at. %, based upon the total number of atoms of the data or navigation layer 116, 112. In certain embodiments, the Fe concentration may be approximately 55 at. % based upon the total number of atoms of the data or navigation layer 116, 112. In additional embodiments, the Pt concentration may range between approximately 45 at. % based upon the total number of atoms of the data or navigation layer 116, 112. In further embodiments, the concentration of element X within a magnetic layer 124 may range between about 0 to 40 at. %, based upon the total number of atoms of the data or navigation layer 116, 112.

In alternative embodiments, the magnetic layers 124 may comprise L1₀ compositions. Examples of L1₀ compositions may include, but are not limited to, cobalt-palladium (CoPd), cobalt-platinum (CoPt), iron-platinum (FePt), and iron-palladium (FePd). In an embodiment, the concentration of cobalt in an L1₀ magnetic material may range between about 30 to 70 at. % based upon the total number of atoms within the material. In another embodiment, the concentration of iron within the L1₀ material may range between about 30 to 70 at. % based upon the total number of atoms within the material. In further embodiments, the concentration of palladium within the L1₀ material may range between about 30 to 70 at. % based upon the total number of atoms within the material. In additional embodiments, the concentration of platinum within the L1₀ material may range between about 30 to 70 at. % based upon the total number of atoms within the material.

In certain embodiments, the data layer 116 may be constructed without requiring parallelism of the bit rows within the data layer 116 and the servo tracks in the navigation layer 112, as the two layers are separated. Instead, the servo information for the bit rows which are stored within the data layer 116 may be identified in a process described in detail below. So configured, the data layer 116 may be constructed from systems which are of relatively high aerial density but are not cost-effective for use in combination with a navigation track on the same layer, owing to contamination and alignment issues. These systems may include, but are not limited to, nanoimprint lithography and self-assembled nanoparticles.

Embodiments of the multi-layered magnetic recording medium 100 may also be used in conjunction with error correction encoding schemes which are highly localized. The navigation layer 112 may be employed for use in recording characterization information, local threshold levels and encoding parameters which are tied locally to specific areas of the disk. In this manner, the type of data encoding employed to read and write data is dependent on the local quality of the magnetic recording medium.

In one embodiment, powerful, but computationally intensive encoding schemes, such as Reed-Solomon (RS) encoding, may be used over areas of the magnetic recording medium which are of low-quality or defective. Alternatively, such a powerful algorithm may be employed over areas of the magnetic recording medium which possess crucial information where substantially no faults may be tolerated.

In another embodiment, less powerful but computationally faster error correcting schemes, such as Reed-Muller (RM) encoding, may be used over regions of the magnetic recording medium which are of higher quality. For example, such high quality areas may exhibit higher signal-to-noise ratios. In alternative embodiments, RM encoding may be used in areas of the magnetic recording medium where some information loss is tolerable in light of the improved computational speed provided by RM encoding.

In one embodiment, a word is a fixed-length string of bits read from the data storage medium and sent to a processor for computation. For instance, a single number with all significant figures and the exponent may be saved within a single word. As the accuracy of computations increase, so does the word length. And with this increase, computation advantages of Reed-Muller over Reed-Solomon encoding become more and more pronounced thanks to a lower decoding complexity. In one non-limiting example, central processing units may employ about 32-bit word lengths, about 64-bit word lengths, or even greater word lengths.

The encoding parameters of RM and RS may be characterized by triplets of numbers [n, k, d], where n is a word length, k is an amount of information recorded in each word, and d is a distance between any two closest (for example, most bitwise similar) words in the encoded hyperspace. For instance, the distance between two words is the number of bits which need to be changed in order to convert the first word into the second word. For example, the distance between the words A and B, (1,1,1,1,1,1,1,1) and (1,1,1,1,1,1,0,0), respectively, is 2. Here the parameters of RM codes are measured in bits, and the parameters of RS codes are given in bytes.

Encoding may be understood through the following non-limiting example. Assume that the word 0 is represented as (0,0,0,0,0) and the word 1 is represented as (1,1,1,1,1). The distance between these two words, d, is 5. In the event of an error which causes (0,0,0,0,0) to be represented as (0,0,1,0,0), the word (0,0,1,0,0) is closer to (0,0,0,0,0) than to (1,1,1,1,1), and may be interpreted as the former. Likewise, in the event of two simultaneous errors, such as in the word (1,0,1,1,0) it can be correctly interpreted as (1,1,1,1,1). Thus, by encoding the words in this fashion, the encoding provides for the correction of up to two errors.

Three errors in (0,0,0,0,0), such as (0,1,0,1,1), however, presents problems for the error correction algorithm. As (0,1,0,1,1) is closer to (1,1,1,1,1) than to (0,0,0,0,0), the error-correcting algorithm will guess wrong and end up with an error. No encoding can provide correction of d/2 or more errors.

Smart decoding schemes, such as decoding schemes developed for RM codes, may guess right at a rate much greater than about 50% even if the number of errors exceeds d/2.

The complexity of both encoding and decoding in the case of Reed-Solomon (RS) code scales as approximately n², while for Reed-Muller (RM) schemes it ranges between approximately nlog(n) and n itself (approximately linear complexity), which provides orders of magnitude advantage in computation speed.

For an RS encoding in the dimension 256, in one embodiment, [n,k,d]=[255,223,33]. The redundancy n-k provides correction of approximately (d−1)/2=16 errors, but makes no claims on correcting of more than about 16 faulty bits. In fact, the conventional Berlecamp-Massey decoder fails to correct combination of more than 16 errors.

RM encoding, using the same word length of about n=256 can take several forms (or orders of encoding):

RM(2,8)→[256, 37, 64]

RM(3,8)→[256, 93, 32]

RM(4,8)→[256, 163, 16]

RM(5,8)→[256, 219, 8]

RM(6,8)→[256, 237, 4]

where the numbers in parentheses indicate the order of the RM encoding. These codes are faster than RS and some correct more errors than RS. For example, RM(2,8) necessarily provides correction of any combination of 31 errors versus the 16 provided by RS. In addition, it corrects many combinations that include more than 32 errors. In another example, RM(3,8) provides correction of 15 errors similar to RS but, on average, corrects much more than that with very high fidelity. RM(5,8) has almost the same code rate as that of RS, with 219 useful bits versus 223 but, as discussed above, is much faster. RM(6,8) surpasses the RS in both speed and density, while being suitable for low-error rate portions.

The advantage of the RM encoding, besides the faster processing it provides over RS encoding (approximately two orders of magnitude faster), is that RM encoding may correct many error patterns beyond its capability of about d/2−1 errors. In contrast, decoding algorithms for RS codes generally fail to correct more than about d/2 errors. For instance, the RM(2,8) code corrects most combinations of about 56 errors, which is in excess of its ability to correct d/2−1=31 errors.

With the longer words, the RM codes show growing advantages over RS codes in both the processing speed and the number of errors corrected. In particular, very long low-rate RM codes of any fixed order r can correct many combinations of slightly less than about n/2 errors, which exceeds their guaranteed correcting capability by the factor of 2^{r} where r is the code order (2 for RM(2,8,), 3 for RM(3,8) etc.).

On the other hand, RM(6,8) may be used over the highly-reliable areas (high quality areas) of the magnetic recording media which exhibit low error rates, substantially surpassing the aforementioned RS code not only in speed, but also in the recording density, due to its higher code rate k/n.

In certain embodiments, a plurality of encoding schemes, such as RM and RS, are employed on a local scale within the magnetic recording medium, rather than a single global disk encoding for different areas of the disk. As a result, the error encoding may move between RS to RM encoding as necessary and adjust the parameters of the encoding as needed for specific disk area. Moreover, the specific areas in which the different encoding schemes are used can be adjusted as the disk wears off and/or information of a different kind is written.

It may be understood, however, that RS and RM encoding schemes are discussed herein for exemplary purposes to demonstrate the flexibility of the proposed recording medium and other error encoding schemes may also be employed without limit Examples include Turbo codes and Low Density Parity Check codes (LDPC).

FIGS. 2A-2C schematically illustrate cross-section embodiments of magnetic recording media 200, 204, 210 having data layers 116 fabricated using different techniques. For example, in FIG. 2A, nanoimprint lithography techniques are employed to form the data layer 116. In FIG. 2B, the data layer 116 is formed through self-assembly processes. In FIG. 2C, the data layer is formed from a continuous media.

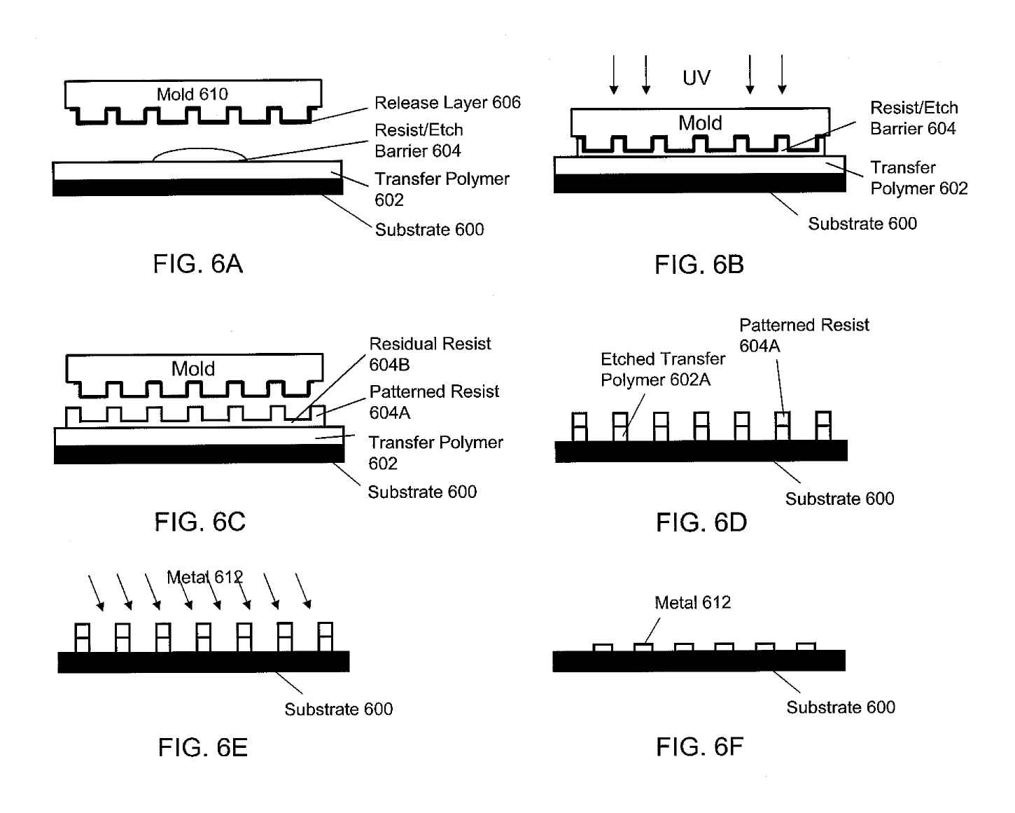

With reference to FIGS. 2A and 6A-6F, nanoimprint lithography is a technique for the fabrication of patterns at about the nanometer scale, less than about 100 nm, which is performed by mechanical deformation of an imprinting medium and lithography. Beneficially, this technique allows the fabrication of substantially uniform bit sizes, enabling substantially one grain to one bit recording. Thus, the bit or grain size itself is no longer defined by crystal growth but by the imprinted pattern. Embodiments of the nanoimprinting process may further comprise techniques discussed in S. Y. Chou, et al, “Nanoimprint Lithography,” J. Vac. Sci. Tech B, Vol. 14, No. 6, Nov/Dec 1996, pp. 4129-4133 and M. D. Austin, et al., “Fabrication of 5 nm line width and 14 nm pitch features by nanoimprint lithography,” Appl. Phys. Lett., Vol. 84, No. 26, 28 June 2004, pp. 5299-5301, and combinations thereof, the entirety of each of which are hereby incorporated by reference.

One embodiment of the nanoimprint lithography process is illustrated in FIGS. 6A-6F. A substrate 600 is prepared with a layer of a transfer polymer 602 upon a first surface of the substrate 600 (FIG. 6A). The substrate 600 may comprise one or more layers of the magnetic recording medium 100 underlying the data layer 116.

A resist polymer/etch barrier 604 is placed upon the transfer polymer 602 and a mold 610 is pressed into the resist/etch barrier 604, causing the regions of the resist 604 in contact with the mold 610 to be pushed away from the mold 610, leaving behind a residual layer of resist 604 (FIG. 6B). In certain embodiments, the mold 610 may comprise one of glass or quartz. In additional embodiments, the mold 610 may be manufactured using focused ion beam patterning.

Subsequently, the mold 610 is removed from contact with the resist 604, which comprises patterned regions 604A and residual regions 604B (FIG. 6C). A release layer 606 may be present upon the surface of the mold 610 in contact with the resist 604 to facilitate release of the mold 610 from the resist 604.

During the patterning process, the resist 604 may be exposed to energy through the mold 610, such as ultraviolet (UV) light. For example, the resist 604 may be exposed when the mold is in contact with the resist, as illustrated in FIG. 6B. The resist 604 is hardened by the energy exposure, protecting the underlying transfer polymer 602 from etchants that, when applied, selectively remove the unhardened residual resist 604A and unprotected transfer polymer 602. The resulting etch yields a layered structure with etched transfer polymer 602A underlying the patterned resist 604A.

Metal 612 is then substantially uniformly deposited upon the substrate 600, covering the remaining hardened, patterned resist 604A and exposed substrate (FIG. 6E). The remaining patterned resist 604A and transfer polymer 602 are then removed, leaving behind the metal upon the substrate 600 (FIG. 6F). In one embodiment, the resist 604 and transfer polymer 602 are removed by a lift-off process.

Embodiments of the metal 612 may be selected so as to provide a magnetic material with perpendicular anisotropy. In one embodiment, the metal 612 may include FePt, which comprises a Face Centered Tetragonal (FCT) array. The unit cell of the FCT lattice comprises iron atoms at the vertices of the cell and at about the center of two opposing faces of the cell, while platinum atoms are positioned at about the center of the remaining faces of the cell. This configuration is also referred to as L10. In alternative embodiments, the metal 612 may comprise at least one of CoPd, CoPt, FePd, Co/Pd multilayers, Co/Pt multilayers, and CoCrPt-based composites. In further embodiments, magnetic materials such as FeCo alloys and Permalloy (NiFe) may be employed, as these materials exhibit substantially strong perpendicular shape-induced anisotropy, if pre-formed into long, narrow pillars. The thickness of individual magnetic layers 124 may range between about 1 to 75 nm. The thickness of stacks of magnetic layers 124 may range between about 1 to 150 nm.

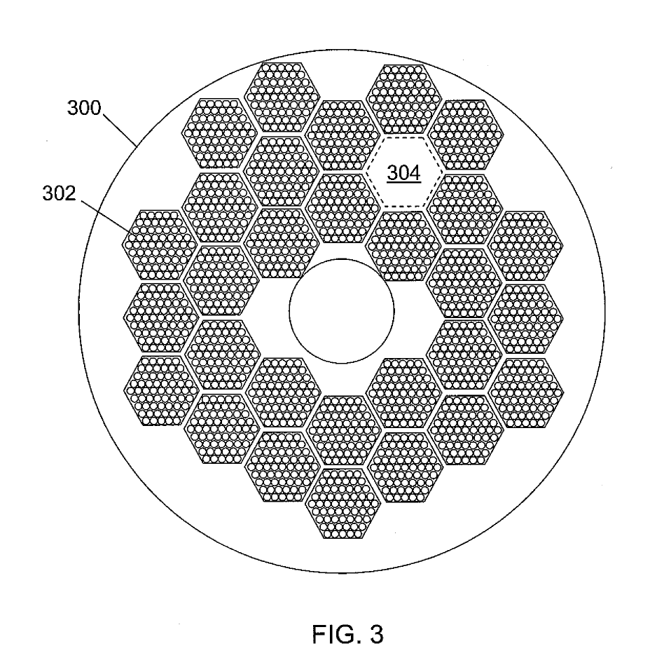

FIGS. 3 and 4 illustrate schematic plan views of embodiments of disks 300 patterned using nanoimprint lithography with hexagonal and rectangular molds, respectively. As illustrated, hexagonal and rectangular imprints 302, 402 formed using the nanoimprint lithography technique may be substantially regular and periodic within the confines of the imprints 302, 402. In certain embodiments, the nanoimprints may be performed using a mold or die which is substantially smaller than the full disk 300. In one embodiment, the mold may be repeatedly imprinted upon the substrate using a selected step size. Beneficially, smaller, and therefore cheaper, imprint stamps may be employed in this manner. In alternative embodiments, the nanoimprint may comprise a full disk imprint, where all the patterns are transferred in a single imprint step. In this manner, higher throughput may be achieved, as the disk 300 may be imprinted within a single pass.

In one embodiment, hexagonal patterns may be employed, as they possess a higher recording density than square patterns. Additionally, hexagonal patterns may benefit from the fact that the angle between the servo tracks and the data rows does not exceed about 15 degrees.

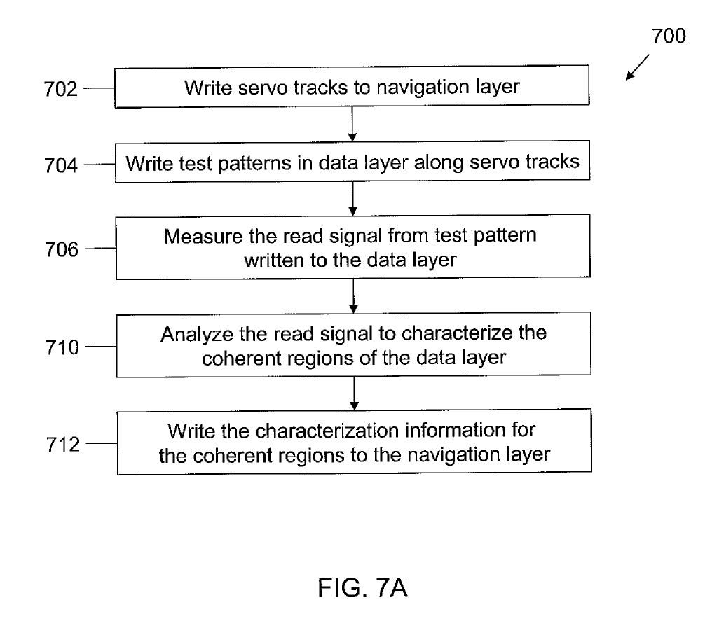

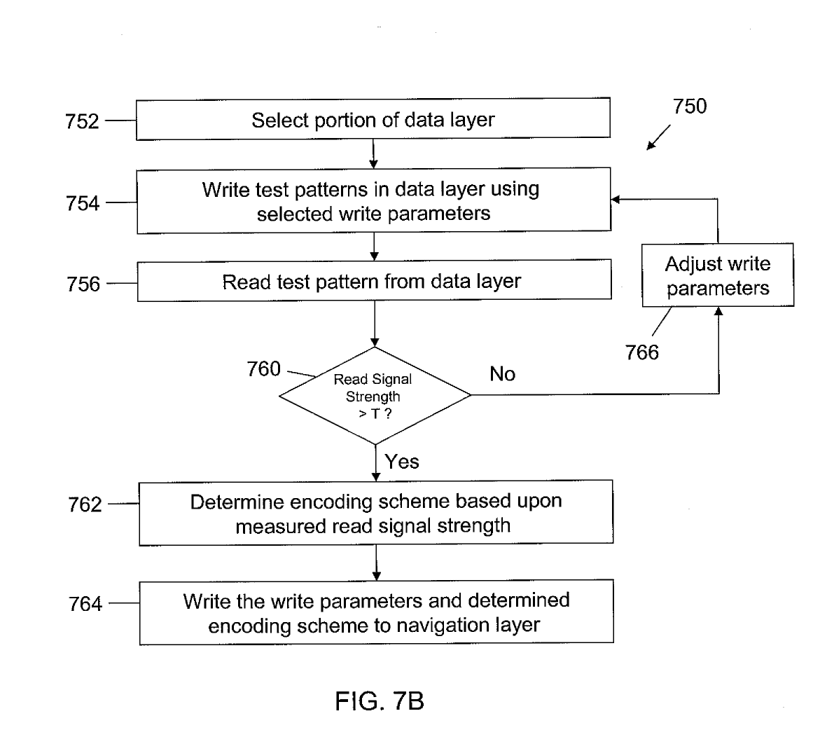

Information regarding at least a portion of the imprints 302, 402 may be recorded in the navigation layer 112. In an embodiment, this information may include, but is not limited to, the position of the center of the imprints 302, 402, the angle between the rows of the data bits within the imprints 302, 402 and the servo track, the location of missing and/or corrupted imprints 302, 402, and one or more encoding schemes for reading and writing data to the imprints 302, 402. Embodiments of processes for identifying the location of missing or corrupted portions of the data layer 116, as well as determining writing parameters and encoding schemes for portions of the data layer 116, are discussed below with respect to FIGS. 7A-7B.

FIG. 2B illustrates a schematic cross-section of one embodiment of the recording medium 204 which is fabricated using self-assembled nanoparticles 206. A self-organized array of magnetic nanoparticles can be potentially used to increase the storage density in magnetic recording. Examples of such nanoparticles 206 may include, but are not limited to, iron platinum (FePt) nanospheres, L1₀ (e.g., high anisotropy magnetic materials) nanodots within lipid shells, monodispersed magnetite (Fe₃O₄) single-domain particles formed from magnetotactic bacteria, other single-domain particles which are exchanged-decoupled from one another by a non-magnetic material.

In one embodiment, the nanoparticles 206 may be deposited on the surface of the disk 300 by wetting the surface with a dilute solution/colloid comprising the nanoparticles and subsequently removing the excess liquid. In an alternative embodiment, the surface may be functionalized with organic polymer molecules which possess a hydrophilic end and a hydrophobic end. Such molecules have a tendency to self-arrange in a monolayer. If the hydrophilic end of the molecules also carries a molecular group with chemical affinity for the nanoparticle coating, a single layer of nanoparticles may be obtained.

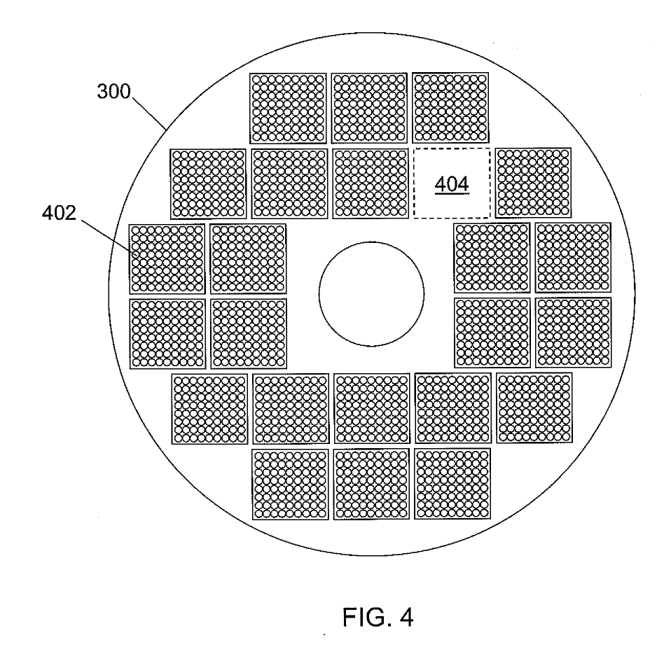

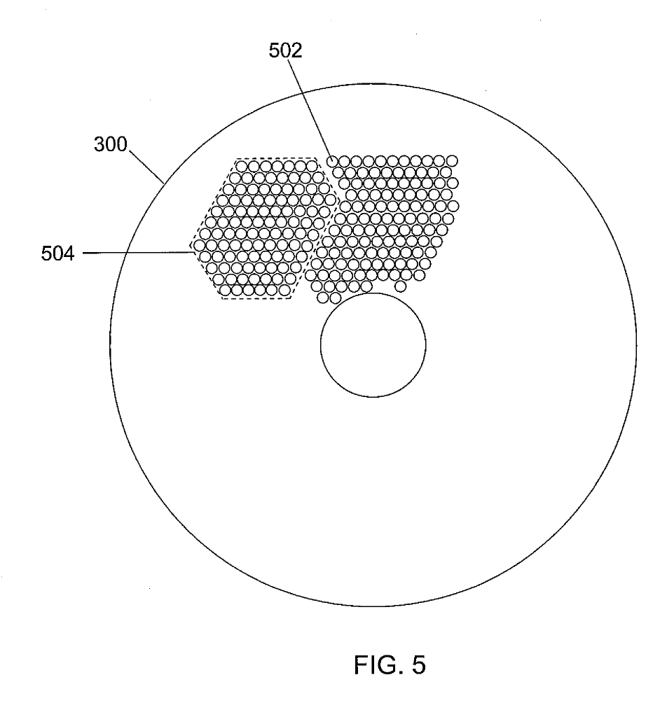

FIG. 5 illustrates a schematic plan view of one embodiment of the self-organized data layer 116. Nanospheres 502 that substantially coat the surface of the disk 300 combine into a quasi-periodic, two-dimensional lattice 504 which possesses a short range order, on the scale of about 100 to 1000 nm. Each raft of such coherent, quasi-crystals 504 can be identified (dashed line, FIG. 5) and the information on its position, angle to the tracks, and approximate shape may be written to the navigation layer 112.

Beneficially, nanoimprint lithography and self-assembled structures require lower tolerances with respect to the cleanliness of the disk surface 300, the quality of the nanoimprint or self-assembled structures upon the disk surface, and positioning of such nanoimprint or self-assembled structures when used in combination with separate data and navigations layers. For example, in one embodiment, simple machinery with relatively large positional tolerances may be employed in the nanoimprinting process, as there the alignment of the imprints 302, 402 is not required for navigation. In another embodiment, regions of the nanoimprinted or self-assembled patterns which are of poor quality for data storage (304, 404), for example due to impurities upon the disk 300 at the time of patterning or inhomogeneities in the pattern, may be identified and ignored while utilizing the remainder of the disk 300. In further embodiments, as discussed above, error correction encoding schemes employed in the data reading/writing process may also be varied so that data written to these poor quality areas 304, 404 employ more computationally intensive encoding schemes which render the areas 304, 404 acceptable for data storage. In all of these examples, the yields of the magnetic recording media are increased, reducing the cost of manufacture of the media.

FIG. 2C illustrates one embodiment of a substantially continuous magnetic media 210 for magnetically recording data to the data layer 116 in the frequency domain. The data layer 116 and the navigation layer 112 comprise substantially continuous, polycrystalline thin films. Examples of such thin films may include, but are not limited to, CoCrPt, FeCo, and Co/Pd-based and Co/Pt-based multilayer structures where such films are separated by non-magnetic layers, and multiple layers of magnetic nanoparticles.

The arrows illustrated in the data layer 116 represent the magnetization of each bit (for example, bits 1-8). In one embodiment, a first plurality of bits, for example, bits 1, 3, 5, and 7, possess a first spatial frequency. In one example, the first spatial frequency possesses 4 bit periods, with bits 1 and 5 up and bits 3 and 7 down. In another embodiment, a second plurality of bits, for example, bits 2, 4, 6, and 8, have a second spatial frequency. In one example, the second spatial frequency possesses 8 bit periods, with bit 2 oriented at about 45 degrees, bit 4 at about 135 degrees, bit 6 at about 225 degrees, and bit 8 oriented at about 315 degrees, each orientation with respect to the horizontal. Continuing the pattern, a tenth bit would adopt the same orientation as bit 2.

Utilizing frequency-based information recording, the signal-to-noise ratio of data which are read may be improved. Furthermore, this technique further allows for multi-level recording in a plurality of data layers, each having its own characteristic frequency bands. As frequency recording is difficult to use for recording head position, however, this technique may be used in combination with the magnetic recording medium 100 to write both servo information and the coordinates and approximate shape of the regions of coherency into the navigation layer 112.

Having described embodiments of the recording medium 100, FIG. 7A illustrates one embodiment of a read/write process workflow 700 for identifying coherent regions or patches of the data layer 116 of the recording medium 100. The method 700 begins in block 702, where servo tracks are recorded into the navigation layer 112.

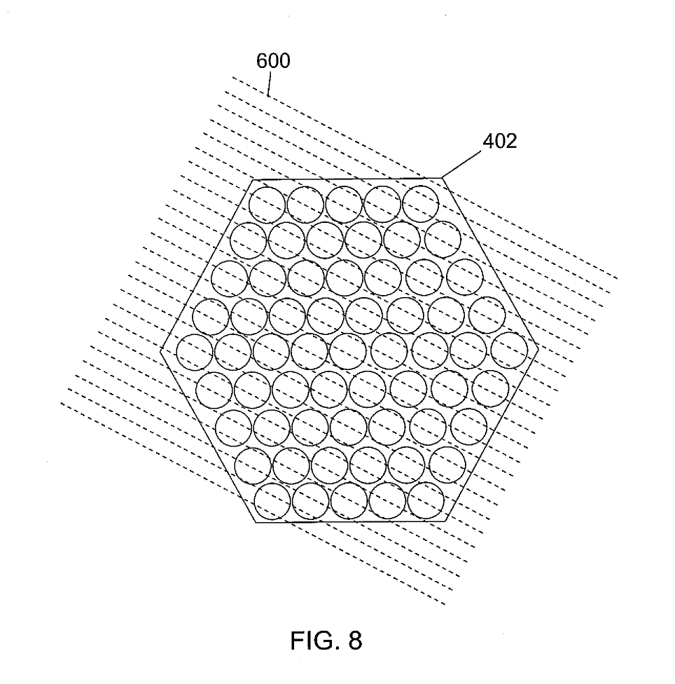

In blocks 704-710, the data are written to the data layer 116 and characterized to identify the coherent regions. In one embodiment, illustrated in FIG. 8, a recording/reading head may follow the servo tracks 800 recorded in the navigation layer 112. In block 704, a known test pattern which passes generally off the center of each row of bits, at a selected angle with respect to the bits, may be written to the data layer 116. In block 706, the head reads the test pattern 800 back in subsequent passes along substantially the same trajectory. One or more parameters of the test pattern, including but not limited to, the amplitude, shape, and signal to noise ratio, may be determined in this fashion. These measured parameters of the test pattern may also be referred to as the read signal of the test pattern.

By analyzing the read signal in block 710, information is gathered which allows characterization of particular coherent blocks of the data layer 116. In one embodiment, the characterization may comprise comparing one or more parameters of the test pattern of a region of the data layer 116 to a comparator for evaluation. For example, the test pattern parameter may comprise the shape of the test pattern and the comparator may comprise a target pattern value. Coherent regions of the data layer may be identified as those that exhibit a read test pattern shape which deviates by less than a selected amount from the target pattern value. Should the shape of the test pattern deviate by greater than the selected amount, that region of the data layer 116 may be labeled as a bad or corrupt region. Bad regions may be omitted from future read/write operations, saving time and potential loss of data.

By comparing the read test pattern to a comparator in this manner, information including, but not limited to, the position of the coherent blocks, size, shape, whether the block is corrupt, and the like can be obtained. This information is in turn written to the navigation layer 112 for later use in navigation in block 712.

FIG. 7B illustrates an embodiment of a method 750 for characterizing writing parameters and encoding schemes for selected regions of the data layers 116. As discussed below, the strength of the read signal in a localized region may be employed to assign appropriate writing parameters and/the encoding scheme for the region.

The method 750 begins in block 752 with the selection of a region of the data layer 116. In block 754, data is written to the data layer 116 using selected write parameters. In an example, the data may comprise a test pattern as discussed above. In further examples, write parameters may comprise parameters including, but not limited to, magnetic field strength.

In blocks 756-760, the data written to the data layer 116 is read and a comparison of the read signal strength (e.g., the amplitude or strength of the magnetic field of the data pattern read from the data layer 116) is made against a second threshold value, T. If the measured read strength is greater than the threshold value, the method 750 moves to block 762, where an encoding scheme is determined. This determination reflects that, given the selected region of the data layer 116, the selected read parameters are sufficient to provide a read signal with adequate strength.

If the measured read strength is less than the threshold value, the method moves to block 766, where the write parameters are adjusted and the method returns to block 754. This determination reflects that, given the selected region of the data layer 116, the selected read parameters may not be sufficient to provide a read signal with adequate strength. Such a circumstance may arise where the selected region of the data layer 116 possesses some imperfections. In an example, the strength of the magnetic field employed to write the test pattern may be increased so as to increase the strength of the resultant read signal.

In block 762, an encoding scheme for the selected region of the data layer 116 is determined based upon the strength of the measured read signal. For example, regions of the data layer 116 with relatively strong read signals are likely to be of higher quality (less imperfections). In these regions, a relatively less powerful but computationally faster error correcting scheme, such as Reed-Muller encoding may be selected. Alternatively, regions of the data layer 116 with relatively weaker read signals are likely to be of lower quality (more imperfections). In these regions, a more powerful, but computationally intensive encoding scheme, such as Reed-Solomon encoding, may be selected.

In block 764, the write parameters and the encoding scheme for the selected region of the data layer 116 are written to the navigation layer 112. Advantageously, through the characterizations discussed above with respect to FIGS. 7A-7B, the reading and writing processes are tailored to specific regions of the magnetic recording medium 100. In this manner, energy and computing resources are conserved when reading and writing to relatively high quality areas of the data layer 116 and expended when reading and writing to relatively poor quality areas of the data layer 116. Furthermore, corrupted portions of the data layer 116 may be substantially avoided altogether, further conserving energy and computing resources.

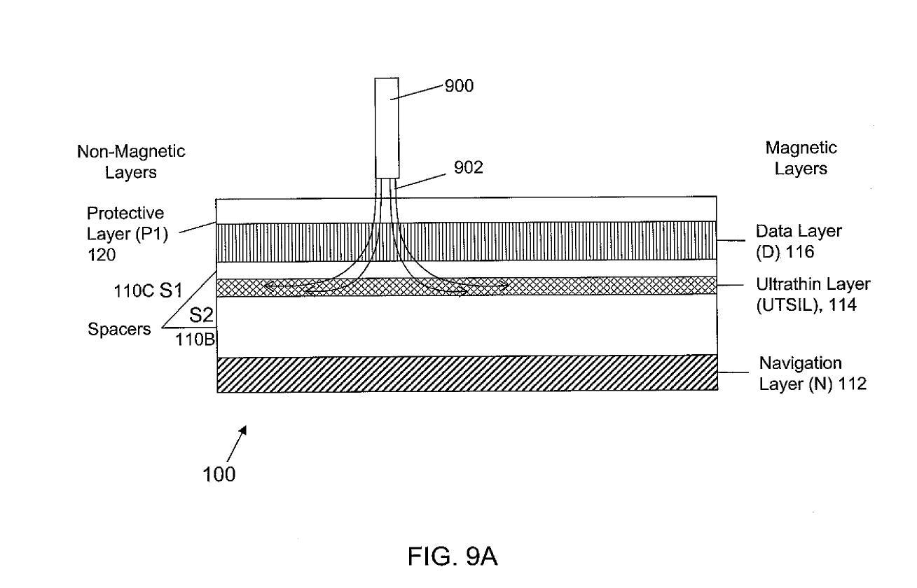

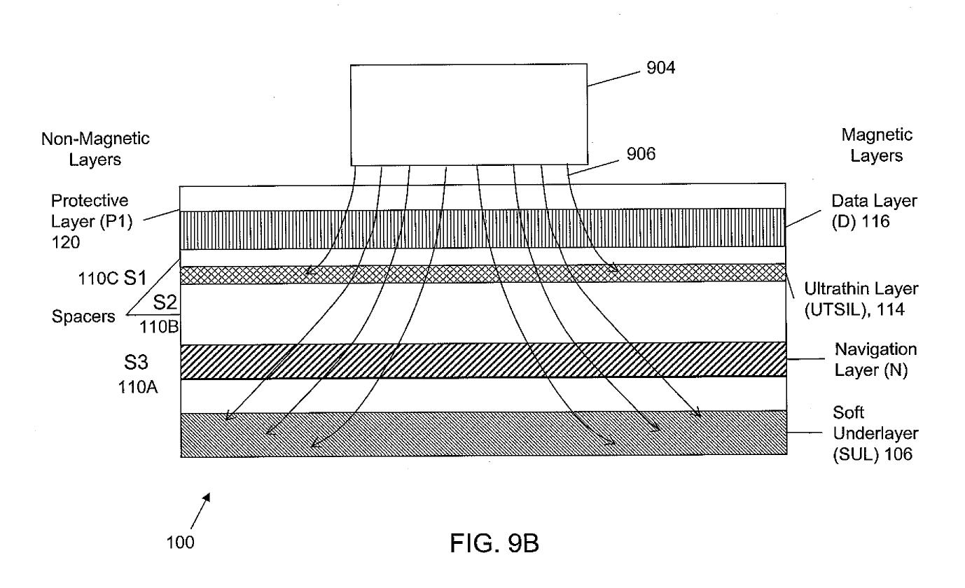

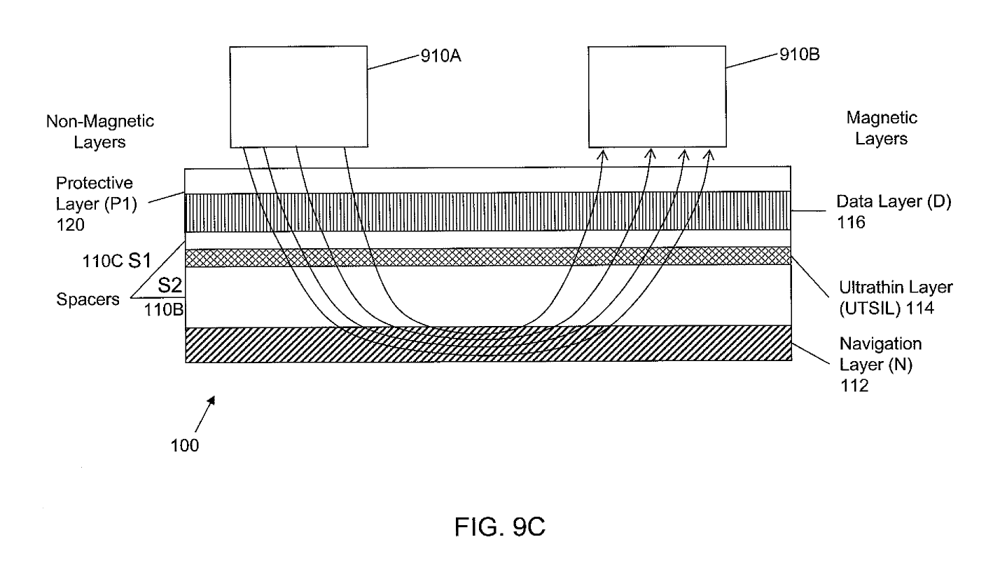

FIGS. 9A-9C illustrate embodiments of a reading/writing process employing the magnetic recording medium 100 of the present disclosure. For clarity, only a portion of the recording medium 100 is illustrated. However, it may be understood that the read and/or write heads 900, 904, 910A, 910B, 1110 discussed below may be configured to move with respect to the recording medium 100. For example, either or both of the recording heads 900, 904, 910A, 910B, 1110 and recording medium 100 may be coupled to one or more actuators. It may be further understood that, while read and/or write heads 900, 904, 910A, 910B, 1110 are discussed individually, one or more may be incorporated together into a single head.

In FIG. 9A, data is written to the data layer 116. In one embodiment, a relatively narrow read/write pole 900, also referred to as read/write head 900, is relatively close to the data layer 116. For example, in one embodiment, the width of the read/write pole 900 ranges between about 20 to 100 nm and the distance of separation of the pole 900 from the center of the data layer 116 is between about 2 to 40 nm. In other embodiments, the separation distance may range between about 2 to 20 nm.

In an embodiment, the narrow read/write pole 900 may be capable of generating a magnetic field of up to a selected value. For example, in certain embodiments, the maximum field may be about 2.6 T. The generated field will decrease as the width of the read/write pole 900 is increased. For example, a doubling of the cross-sectional area of the read/write pole 900 will approximately halve the magnetic field.

The combination of a narrow read/write pole 900 and short distance to the data layer 116 leads to a strongly divergent field configuration and to a relatively small magnetic flux, despite the relatively strong magnetic field 902 generated by the read/write head 900. Owing at least in part to the divergent field, the strength of the magnetic field generated by the narrow read/write pole 900 attenuates quickly. As a result, the magnetic field strength in the data layer 116 may be greater than or equal to the magnetic coercivity of the data layer 116, enabling the narrow read/write pole 900 to write data to the data layer 116. Concurrently, owing to the attenuation of the generated field strength, the magnetic field strength in the navigation layer 112 may be less than the magnetic coercivity of the navigation layer 112. This configuration decreases the likelihood of writing data to the navigation layer 112 while writing to the data layer 116.

The attenuation in the magnetic field strength may be tailored to inhibited writing to the navigation layer 112. In one embodiment, the distance between the narrow read/write pole 900 and the navigation layer may be varied. In another embodiment, the UTSIL 114 may be interposed between the narrow read/write pole 900, partially shielding the navigation layer 112 from magnetic fields generated during writing operations to the data layer 116. In further embodiments, the distance between the narrow read/write pole 900 and the navigation layer may be varied and the UTSIL 114 may be employed. In alternative embodiments, the UTSIL 114 may be omitted and the field divergence alone may be relied upon to inhibit such parasitic writing to the navigation layer 112.

In FIG. 9B, data is written to the navigation layer 112. In contrast to the read/write process of FIG. 9A, a wider pole 904 is employed for writing to the navigation layer 112. In one embodiment, the pole 904 possesses a width between about 100 to 400 nm.

As discussed above, due to the larger width of the read/write pole 904, the magnetic fields generated by this pole 904, the magnetic fields which it generates will be weaker than those of the narrow read/write pole 900. Concurrently, the pole 904 generates a large flux, due to its large area. As such, the UTSIL 114, when present, is substantially unable to block the flux, even while being completely saturated.

In certain embodiments, the strength of the magnetic field 806 generated by the wide read/write pole 904 is less than the magnetic coercivity of the data layer. The strength of the magnetic field generated by the wide read/write pole 904 is greater than or equal to the magnetic coercivity of the navigation layer. As such this write field 806 is substantially too weak to perturb the high-coercivity bits of the data layer 116 but is sufficient to write to the navigation layer 112. Thus, it may be understood that the magnetic field achievable by the read/write poles 900, 904 can be adjusted according to the relative coercivity values of the navigation and data layers, up to about the maximum value, by changing the cross-sectional area of the poles 900, 904 via the width.

In certain embodiments, a tri-pole read/write head may be used for the writing process. In alternative embodiments, two independent heads which share the same slider or actuator may be employed. In further alternative embodiments, heat-assisted recording techniques may be employed to allow for proper writing to the data layer 116, without writing to the navigation layer 112 using a single write head.

In further embodiments, data may be written to navigation layers 112 which are configured with longitudinal anisotropy, as illustrated in FIG. 9C. The breadth of the navigation recording poles 910A, 910B allows high-density recording of navigation information. However, this poses substantially no difficulty, as the amount of navigation information may be several orders of magnitude lower than the amount of data recorded within the data layer 116.

In a further advantage, longitudinal recording to the navigation layer 112 may substantially avoid writing data to data layers 116 which are configured for perpendicular recording. In one example, the longitudinal write field is in the wrong orientation to substantially write to the data layer 116.

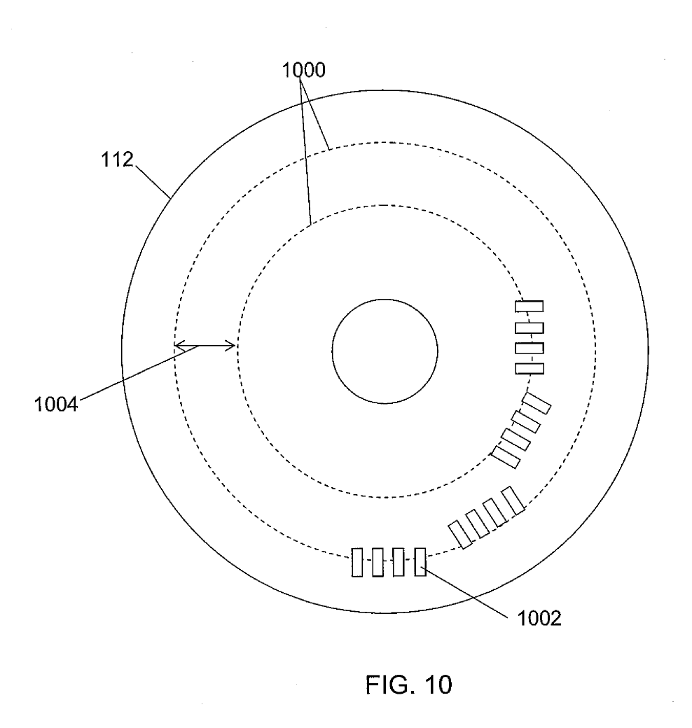

Beneficially, despite the breadth of the navigation recording poles, precise positioning of the write head along the tracks 1000 is possible. For example, as illustrated in FIG. 10, redundant servo markers 1002 of different spatial frequencies, shifted by part of the track width 1004 with respect to one another, may be written to the navigation layer 112. In this manner, precise positioning may be achieved. In this fashion, the shifted markers provide enhanced precision in navigating to a desired position. In alternative embodiments, the servo tracks 1000 may be used for a fast, rough positioning, while the high-precision markers 1002 may be written to the data layer 116.

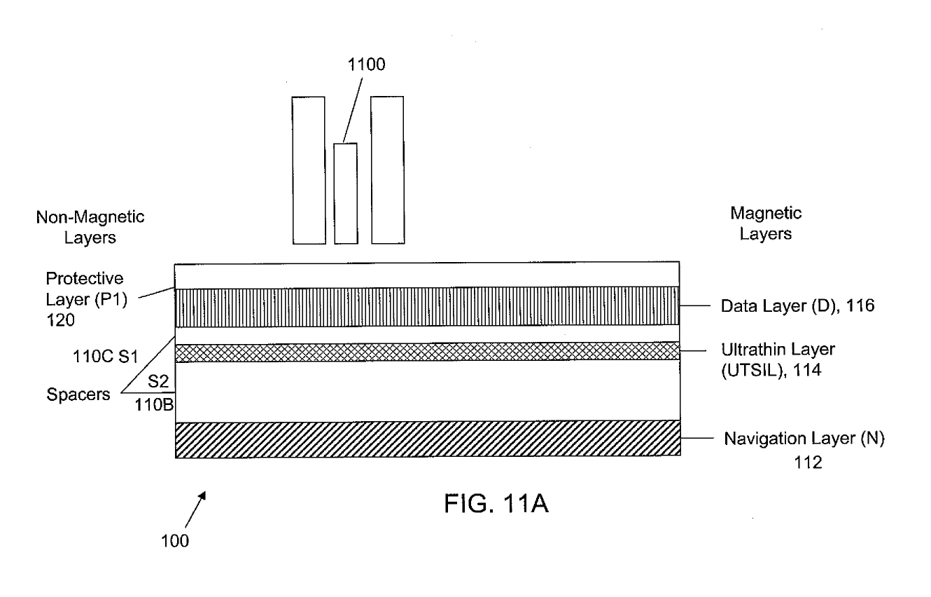

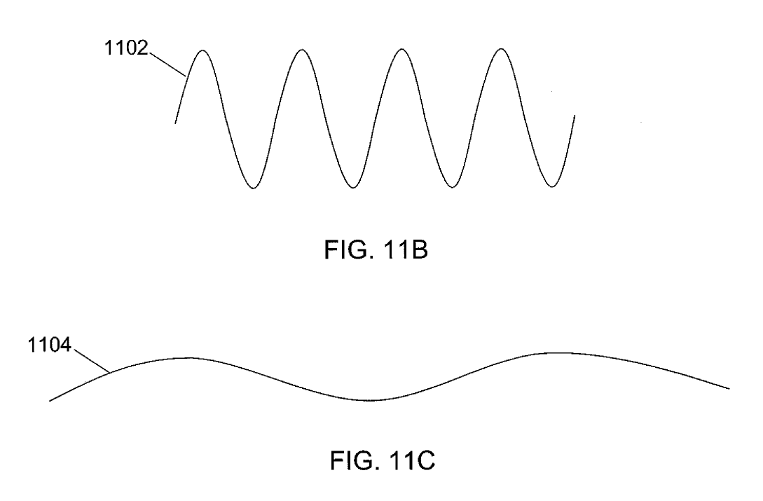

FIGS. 11A-11C illustrate one embodiment of the reading process. As illustrated in FIG. 11A, a magnetoresistive read element 1100 moves over the medium 100.

The read signals 1102, 1104, representing data and navigation signals, that are detected in this process are illustrated in FIGS. 11B and 11C, respectively. The data signal 1102 is substantially stronger and changes on a relatively short spatial scale. The navigation signal 1104 is weaker and has a relatively longer wavelength than the data signal 1102, however it may be effectively refined by locking into its signal frequency. In alternative embodiments, read elements of the same slider may be employed for reading the data and navigation information.

### EXAMPLE

The following example demonstrates that the magnetization of the data and navigation layers of embodiments of the disclosed magnetic media may be independently changed. It may be understood that the example is presented for illustrative purposes and should not be construed to limit the scope of the disclosed embodiments

An embodiment of the magnetic media of the present disclosure was fabricated on a glass substrate and its magnetic hysteresis properties examined. The magnetic layers, from bottom (closest to the substrate) to top, comprised: a first palladium seed layer of about 5 nm, a first cobalt/palladium stack (which may function as the navigation layer) comprising [cobalt (about 0.36 nm)/palladium (about 0.55 nm)] ×7, a second palladium seed layer of about 5.3 nm thickness, a second cobalt/palladium stack (which may function as the data layer) comprising [cobalt (0.36 nm)/palladium (about 0.55 nm)] ×7, and a protective palladium layer having a thickness of about 5.3 nm. The first cobalt/palladium stack was deposited by sputtering under pressure of approximately 5 mtorr and the second stack was sputtered employing a pressure of approximately 30 mtorr.

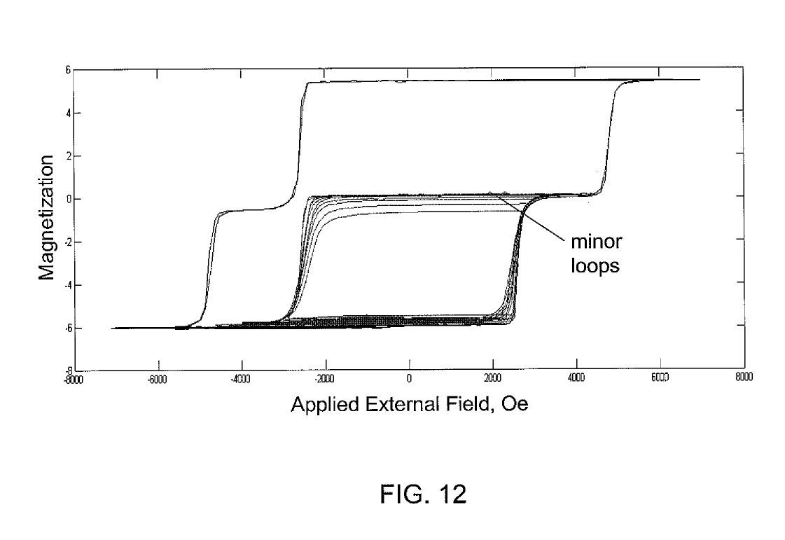

FIG. 12 illustrates a hysteresis curve measured from an embodiment of the above magnetic recording medium upon application of an external magnetic field ranging from about −7000 to 7000 Oe, with magnetization measured in arbitrary units. It may be observed that the hysteresis curve exhibits four states of magnetization. The first state is observed at an arbitrary magnetization value of approximately −6 for field strengths that are less than approximately −5600 Oe. This measurement indicates that the magnetization of the two stacks are oriented parallel to each other, in the down direction, and are additive.

As the field strength is increased above approximately 2500 Oe, the magnetization begins to increase until it reaches the second state, at an arbitrary magnetization value of approximately 0. This change in the measured magnetization indicates that the magnetization orientation of the lowest coercivity stack has changed to the up direction, becoming antiparallel with the other. The second magnetization state persists from approximately 3500 to 5000 Oe.

Further increasing the field strength beyond approximately 4500 Oe, the magnetization is again observed to rise from the level of the second state to the third state, at an arbitrary magnetization value of approximately 5.5. This change in the measured magnetization indicates that the magnetization orientation of the stack that was formerly in the down orientation in the second state has changed to the up direction. Once the third state is reached, further increases in the field strength do not result in further magnetization increases, indicating that the 3-D magnetic media is approximately saturated.

Upon decreasing the field strength below approximately −2500 Oe, the magnetization is observed to decrease from the level of the third state to the fourth state, at an arbitrary magnetization value of approximately −0.5. It may be observed that the fourth state persists from approximately −3500 to 5000 Oe. Further reductions in the field strength below about −5000 Oe result in the magnetization returning to approximately the level of the first state, at an arbitrary magnetization value of approximately −6.

In further embodiments, the field strength may be adjusted such that only one layer is switched in magnetization orientation, while the other maintains its magnetization state, as illustrated by the minor loops.

Thus, it may be observed that the magnetization of data and navigation layers of embodiments of the disclosed magnetic media may be independently switched, without influencing the other layer.

Although the foregoing description has shown, described, and pointed out the fundamental novel features of the present teachings, it will be understood that various omissions, substitutions, and changes in the form of the detail of the apparatus as illustrated, as well as the uses thereof, may be made by those skilled in the art, without departing from the scope of the present teachings. Consequently, the scope of the present teachings should not be limited to the foregoing discussion, but should be defined by the appended claims.

What is claimed is:

1. A magnetic recording medium, comprising:
a first recording layer to which a first data may be magnetically recorded;
a second recording layer to which a second data may be magnetically recorded, wherein the first recording layer is positioned beneath the second recording layer and wherein a magnetic coercivity of the second recording layer is greater than the first recording layer;
and wherein the first data comprises navigation information for identifying a location of the second data within the second recording layer.

2. The magnetic recording medium of claim 1, wherein the second recording layer comprises a plurality of metallic patterned regions.

3. The magnetic recording medium of claim 2, wherein the metallic regions comprise FePt, CoPd, CoPt, FePd, CoCrPt, Co/Pd and Co/Pt multilayers, FeCo, NiFe, and combinations thereof.

4. The magnetic recording medium of claim 3, wherein the second recording layer comprises a plurality of layers.

5. The magnetic recording medium of claim 1, wherein the second recording layer comprises a plurality of magnetic nanoparticles.

6. The magnetic recording medium of claim 5, wherein the nanoparticles comprise at least one of CoPd, FePt, Fe₃O₄, and L1₀ materials.

7. The magnetic recording medium of claim 1, wherein second recording layer is configured for perpendicular recording.

8. The magnetic recording medium of claim 1, further comprising at least one soft magnetic layer interposed between at least a portion of the first and second recording layers.

9. The magnetic recording medium of claim 1, wherein the first data further comprise local threshold levels and encoding parameters tied locally to specific areas of the second recording layer for use with error correction encoding schemes.

10. A magnetic recording system comprising:
a data layer to which first data may be magnetically recorded;
a navigation layer to which navigation data may be magnetically recorded, wherein a magnetic coercivity of the data layer is greater than the navigation layer and wherein the navigation data identifies the location of the first data within the data layer; and
a plurality of read/write poles within a single head, capable of separately reading and writing data to the data and navigation layers.

11. The magnetic recording system of claim 10, further comprising an error-correction encoding system which varies the data encoding scheme employed for writing the first data to the data layer on the basis of the magnetic field strength of the first data.

12. The magnetic recording system of claim 10, further comprising a plurality of magnetic poles configured to independently read and write data to the data and navigation layers.

13. The magnetic recording system of claim 11, further comprising a first magnetic pole for reading and writing to the navigation layer and a second magnetic pole for reading and writing to the data layer, wherein the first magnetic pole possesses a width which is smaller than that of the second magnetic pole and generates a magnetic field which is greater than that of the second magnetic pole.

14. A method of recording data to a magnetic recording medium, comprising:
selecting a portion of data layer of the magnetic recording medium to which data is to be recorded;
writing predetermined data to the data layer using selected write parameters;
determining a strength of the magnetic field of the data written to the data layer using the selected write parameters;
comparing the measured magnetic field strength to a threshold value;
determining an encoding scheme based upon the strength of the measured magnetic field when the measured magnetic field strength is greater than or equal to the threshold value; and
writing the write parameters and determined encoding scheme for the selected portion of the data layer to a navigation layer of the magnetic recording medium;
wherein the data and navigation layers of the magnetic recording medium are configured as separate layers of the magnetic recording medium.

15. The method of claim 14, further comprising:
adjusting the write parameters when the measured magnetic field strength is less than the threshold value;
writing predetermined data to the data layer using the revised write parameters;
determining a strength of the magnetic field of the data written to the data layer using the revised write parameters; and
comparing the measured magnetic field strength to the threshold value.

16. The method of claim 14, wherein the error correction scheme is changed upon detection of a change in the local threshold level greater than a selected amount.

17. The method of claim 14, further comprising measuring the level and noise of the read signal and changing at least one of the local gain and threshold level when the signal-to-noise ratio changes by greater than a selected amount.

18. The method of claim 14, wherein the error correction scheme is selected from at least one of Reed-Solomon encoding, Reed-Muller encoding, Turbo codes, and Low Density Parity Check.

19. A method of fabricating a magnetic recording medium, comprising:
providing a substrate;
depositing a first magnetic layer over the substrate to which first data may be magnetically written and read; and
depositing a second magnetic layer over the first magnetic layer to which second data may be magnetically written and read;
wherein the magnetic coercivity of the second magnetic layer is greater than that of the first magnetic layer and wherein the first data comprises navigation information for identifying a location of the second data within the second recording layer.

20. The method of claim 19, wherein depositing the second magnetic layer comprises depositing a metallic layer over a plurality of patterned regions.

21. The method of claim 20, wherein the second magnetic layer comprises at least one of FePt, CoPd, CoPt, FePd, CoCrPt, Co/Pd and Co/Pt multilayers, FeCo, NiFe, and combinations thereof.

22. The method of claim 19, wherein depositing the second magnetic layer comprises depositing self-assembling magnetic nanoparticles.

23. The method of claim 22, wherein the magnetic nanoparticles comprise at least one of CoPd, FePt, Fe₃O₄, and L1₀ materials.

24. The method of claim 19, further comprising depositing at least one further comprising at least one soft magnetic layer between at least a portion of the first and second magnetic layers.

25. A magnetic recording device for reading and writing data magnetically to a magnetic recording medium, comprising:
a reading and writing head, comprising:
a first magnetic pole; and
a second magnetic pole;
wherein the width of the second magnetic pole is less than the width of the first magnetic pole and wherein the second magnetic pole is configured to generate a maximum magnetic field strength which is greater than that of the first magnetic pole.

26. The magnetic recording device of claim 25, further comprising an actuator for relative positioning of the reading and writing head with respect to the magnetic recording medium.

27. The magnetic recording device of claim 25, wherein the width of the second magnetic pole ranges between 20 to 100 nm.

28. The magnetic recording device of claim 25, wherein the width of the first magnetic pole ranges between 100 to 400 nm.

29. The magnetic recording device of claim 25, wherein the maximum magnetic field independently generated by the first and second magnetic poles is less than 2.6 T.

30. The magnetic recording device of claim 25, further comprising a magnetic recording medium, comprising:
a first layer to which a first data may be magnetically recorded; and
a second layer to which a second data may be magnetically recorded, wherein the first recording layer is positioned beneath the second recording layer and wherein a magnetic coercivity of the second recording layer is greater than the first recording layer.

31. The magnetic recording device of claim 30, wherein the magnetic field of the first magnetic pole is configured to write data to the first recording layer without writing data to the second recording layer and wherein the magnetic field of the second magnetic pole is configured to write data to the second recording layer without writing data to the first recording layer.

32. The magnetic recording system of claim 31 wherein the first magnetic pole generates a magnetic field such that:
the magnetic field strength in the second recording layer is less than the magnetic coercivity of the second recording layer; and
the magnetic field strength in the first recording layer is greater than or equal to the magnetic coercivity of the first recording layer.

33. The magnetic recording system of claim 32, wherein the second magnetic pole generates a magnetic field such that:
the magnetic field strength in the second recording layer is greater than or equal to the magnetic coercivity of the second recording layer; and
the magnetic field strength in the first recording layer is less than the magnetic coercivity of the first recording layer.

34. The magnetic recording system of claim 32, wherein the strength of the magnetic field generated by the second magnetic pole attenuates due to at least one of the distance between the second magnetic pole and the first recording layer, a soft magnetic underlayer interposed between the second magnetic pole and the first recording layer and combinations thereof.

35. The magnetic recording device of claim 31, wherein the flux of the magnetic field generated by the second magnetic pole for writing to the second recording layer is less than the flux of the magnetic field generated by the first magnetic pole for writing to the first recording layer.

36. The magnetic recording device of claim 31, wherein the strength of the magnetic field generated by the second magnetic pole for writing to the second recording layer is greater than the strength of the magnetic field generated by the first magnetic pole for writing to the first recording layer.
